(19) United States
(12) Patent Application Publication
(10) Pub. No.: US 2022/0158407 A1
(43) Pub. Date: May 19, 2022

(54) RADIALLY POLARIZED OPTICAL PARAMETRIC AMPLIFIER INSENSITIVE TO POLARIZATION AND AMPLIFICATION METHOD THEREOF

(71) Applicant: SHENZHEN UNIVERSITY, Shenzhen (CN)

(72) Inventors: Haizhe Zhong, Shenzhen (CN); Chengchuan Liang, Shenzhen (CN); Shengying Dai, Shenzhen (CN); Jiefeng Huang, Shenzhen (CN); Saisai Hu, Shenzhen (CN)

(21) Appl. No.: 17/197,048

(22) Filed: Mar. 10, 2021

Related U.S. Application Data
(63) Continuation of application No. PCT/CN2020/129782, filed on Nov. 18, 2020.

(51) Int. Cl. H01S 3/094; H01S 3/10; H01S 3/06

(52) U.S. Cl. CPC H01S 3/094076; H01S 3/0602; H01S 3/10053; H01S 3/10061

(57) ABSTRACT

A radially polarized optical parametric amplifier insensitive to polarization is provided by the present invention, which comprises a laser module and a nonlinear crystal satisfying the type-II phase matching or the type-II quasi-phase matching condition, wherein the laser module is configured to generate two laser beams, namely the pump light and the signal light with an arbitrary polarization state, the wavelengths of the pump light and the signal light are degenerate or nearly degenerate; and the nonlinear crystal is provided in the emergent beamline of the laser module to perform optical parametric amplification of the signal light by using the pump light.

### CROSS REFERENCE TO RELATED APPLICATIONS

The present application is a Continuation application of PCT Application No. PCT/CN2020/129782 filed on Nov. 18, 2020, the contents of which are incorporated herein by reference in their entirety.

### TECHNICAL FIELD

The present invention relates to the technical field of lasers, in particular to a radially polarized optical parametric amplifier insensitive to polarization and an amplification method thereof.

### BACKGROUND

A vector beam is a spatially structured beam with special polarization distribution, which shows many novel characteristics different from linearly polarized or circularly polarized light, and plays a vital role in the Intense-Field interaction with matters. The typical representative of the vector beam is radially polarized light. Compared with conventional uniformly polarized light, the polarization of radially polarized light is axisymmetrically distributed. Radially polarized light can be used in many places, like guide and capture particles, accelerate particles, improve the resolution of microscope, cut metal, and increase storage density. With the deepening of people's understanding of radially polarized light, radially polarized light will be applied in more fields, and at the same time, the requirement for the peak power of radially polarized light is getting higher and higher.

Making use of the second-order optical nonlinearity, the energy transfer between three laser beams of different frequencies can be realized. Optical Parametric Amplification (OPA) can transfer the energy of pump light with frequency ωp to signal light with frequency ωs (ωp>ωs), and at the same time, obtain a third light with frequency ωi (ωp=ωs+ωi) (referred to as idler light). Optical parametric amplification has the characteristics of large single-pass gain, non-spontaneous stimulated emission (ASE) and broadband gain spectrum.

However, Phase Matching (PM) is the premise of all nonlinear optical processes. Regardless of an angle phase matching or a quasi-phase matching method is used, only one specified linear-polarization combination can meet the phase matching condition. However, radially polarized light contains all possible linear polarization states, which essentially limits the possibility of applying optical parametric amplification to radially polarized light.

Therefore, it is necessary to improve the configuration of the optical parametric amplifier.

### SUMMARY

The technical problem to be solved by the present invention is to provide a radially polarized optical parametric amplifier insensitive to polarization and an amplification method thereof, aiming at solving the problem that optical parametric amplification does not apply to radially polarized light.

In order to solve the above technical problems, the technical scheme adopted by the present invention is as follows.

A first aspect of an embodiment of the present invention provides a radially polarized optical parametric amplifier insensitive to polarization, comprising:

a laser module and a nonlinear crystal satisfying the type-II phase matching or the type-II quasi-phase matching condition, wherein the laser module is configured to generate two laser beams, namely the pump light and the signal light with an arbitrary polarization state, the wavelengths of the pump light and the signal light are degenerate or nearly degenerate; and the nonlinear crystal is provided in the emergent beamline of the laser module to perform optical parametric amplification of the signal light by using the pump light.

In some embodiments, different nonlinear crystals are used correspondingly for the signal light with different wavelengths, so that the gain of the o-polarized component and the e-polarized component of the signal light are equivalent and the signal light passing through the nonlinear crystal is capable of maintaining the original polarization state.

In some embodiments, the laser module comprises a first laser and a second laser, wherein the first laser emits the pump light and the second laser emits the signal light;

alternatively, the laser module comprises a third laser, a beam splitter and a frequency converter, wherein the laser emitted by the third laser passes through the beam splitter and two laser beams are obtained, one of which is the pump light and the other passes through the frequency converter to generate the signal light.

In some embodiments, the third laser is a Ti:sapphire femtosecond laser, which emits femtosecond pulsed laser, and the femtosecond pulsed laser passes through the beam splitter and two laser beams are obtained, one of which is the pump light and the other passes through the frequency converter to generate the signal light.

In some embodiments, the laser module further comprises a laser mode converter provided in the beamline of the signal light for changing the polarization state of the signal light.

In some embodiments, the laser mode converter is a vortex retarder for converting the linearly polarized signal light into the radially polarized signal light.

In some embodiments, the laser module further comprises a lens and a delay optical path, wherein the delay optical path is provided in the beamline of the signal light or the pump light, so that the signal light and the pump light are synchronized in time; the lens is provided in the beamline of the signal light or that of the pump light so that the spot of the signal light is smaller than or equal to the spot of the pump light.

In some embodiments, when the nonlinear crystal performs optical parametric amplification of the signal light by using the pump light, another laser beam will be generated, which is idler light; in the nonlinear crystal, a non-collinear phase matching method is used; the non-collinear phase matching method is that the transmission directions of the signal light and the pump light are non-collinear, so as to separate the signal light passing through the nonlinear crystal from the pump light and the idler light.

Optionally, in the nonlinear crystal, a collinear phase matching method is used; the collinear phase matching method is that the transmission directions of the signal light and the pump light are collinear, and the optical parametric amplifier further comprises a beam splitter which is provided in the emergent beamline of the nonlinear crystal to separate the signal light passing through the nonlinear crystal from the pump light and the idler light.

In some embodiments, the beam splitter is a dichroic mirror which is highly transparent to the signal light and highly reflective to the pump light and the idler light.

Optionally, the beam splitter is a dichroic mirror which is highly transparent to the pump light and the idler light and highly reflective to the signal light.

The second aspect of the embodiment of the present invention provides an optical parametric amplification method insensitive to polarization, which is applied to the radially polarized optical parametric amplifier insensitive to polarization as described in the first aspect of the embodiment of the present invention, wherein the optical parametric amplification method insensitive to polarization comprises:

using the laser module to generate two laser beams, namely the pump light and the signal light with an arbitrary polarization state, wherein the wavelengths of the pump light and the signal light are degenerate or nearly degenerate;

directing the pump light and the signal light through a nonlinear crystal, and performing optical parametric amplification of the signal light by using the pump light, wherein the nonlinear crystal is a nonlinear crystal satisfying the type-II phase matching or the type-II quasi-phase matching condition.

It can be seen from the above description that compared with the prior art; the present invention has the following beneficial effects.

The pump light and the signal light with an arbitrary polarization state (such as radially polarized light) generated by the laser module enter the nonlinear crystal satisfying the type-II phase matching or the type-II quasi-phase matching condition, and optical parametric amplification of the signal light is performed by using the pump light, thereby obtaining the high-peak-power ultrashort pulsed laser with the initialized polarization state. The radially polarized optical parametric amplifier insensitive to polarization according to the present invention is insensitive to the polarization of signal light, that is, no matter what kinds of the polarization state of signal light is, the power of signal light obtained after being amplified by pump light is only related to the power of seeding signal light and has nothing to do with its polarization state. The optical parametric amplifier can be used for parametric amplification of vector beams such as the radially polarized light to obtain the high-peak-power radially polarized ultrashort pulsed laser.

### BRIEF DESCRIPTION OF THE DRAWINGS

In order to explain the embodiments of the present invention or the technical solutions in the prior art more clearly, the drawings used in the description of the embodiments or the prior art will be briefly introduced. Obviously, the drawings in the following description are only some embodiments of the present invention, rather than all embodiments. For those skilled in the art, other drawings can be obtained according to the provided drawings without paying creative labor.

FIG. 1 is a schematic diagram of a radially polarized optical parametric amplifier insensitive to polarization according to embodiment 1 of the present invention;

FIG. 2 is a schematic diagram of a radially polarized optical parametric amplifier insensitive to polarization according to embodiment 2 of the present invention;

FIG. 3 is a schematic diagram of a radially polarized optical parametric amplifier insensitive to polarization according to embodiment 3 of the present invention;

FIG. 4 is a schematic diagram of a radially polarized optical parametric amplifier insensitive to polarization according to embodiment 4 of the present invention;

FIG. 5 is a curve showing the evolution of the average pulse energy and gain of the radially polarized light after being amplified versus the average pulse energy of the seeding radially polarized light according to embodiment 4 of the present invention;

FIG. 6 is a CCD camera image of the spot of the amplified radially polarized light after appropriately attenuating the pulse energy of the amplified radially polarized light according to embodiment 4 of the present invention;

FIG. 7 is a schematic flow chart of an optical parametric amplification method insensitive to polarization according to embodiment 5 of the present invention.

### DESCRIPTION OF THE EMBODIMENTS

In order to make the object, technical scheme and advantages of the present invention clearer, the present invention will be further described in detail combining the drawings and embodiments, wherein the same or similar reference numerals refer to the same or similar elements or the elements with the same or similar functions throughout. It should be understood that the specific embodiments described herein are only used to explain the present invention, and are not used to limit the present invention. In addition, the technical features involved in each embodiment of the present invention described below can be combined with each other as long as they do not conflict with each other.

### Embodiment 1

Refer to FIG. 1, which is a schematic diagram of a radially polarized optical parametric amplifier insensitive to polarization according to embodiment 1 of the present invention.

As shown in FIG. 1, the radially polarized optical parametric amplifier insensitive to polarization according to embodiment 1 of the present invention comprises a laser module 1 and a nonlinear crystal 2 satisfying the type-II phase matching or the type-II quasi-phase matching condition, wherein the laser module 1 is configured to generate two laser beams which are synchronized in time and collinear or non-collinear, namely the pump light 3 and the second signal light 5 with an arbitrary polarization state converted from the first signal light 4, the nonlinear crystal 2 is provided in the emergent beamline of the laser module 1 to perform optical parametric amplification of the second signal light 5 by using the pump light 3, and the wavelengths of the pump light 3 and the signal light 5 are degenerate or nearly degenerate.

Specifically, the second signal light 5 is of arbitrary polarization, including but not limited to radially polarized light, linearly polarized light, circularly polarized light, etc.

Specifically, the wavelength of the first signal light 4 can be detuned in a small wavelength range. At this time, it is necessary to adjust the angle of the nonlinear crystal 2 correspondingly, so that the gain of the o-polarized component and the e-polarized component of the signal light 5 are equivalent and the signal light 5 passing through the nonlinear crystal 2 is capable of maintaining the original polarization state.

For example, in the actual working process, the pump light 3 and the second signal light 5 generated by the laser module 1 enter the nonlinear crystal 2 in a collinear or non-collinear manner. The nonlinear crystal 2 preforms optical parametric amplification of the second signal light 5 by using the pump light 3. After the optical parametric amplification of the second signal light 5, in addition to the amplified second signal light 5 and the attenuated pump light 3, another laser beam will be generated at the same time, which is referred to as idler light.

It should be noted that the nonlinear crystal 2 satisfies the type-II phase matching or the type-II quasi-phase matching condition, that is to say, when the o-polarized component of the second signal light 5 is subjected to optical parametric amplification by using the nonlinear crystal 2, the e-polarized idler light can be correspondingly obtained; when the e-polarized component of the second signal light 5 is subjected to optical parametric amplification by using the nonlinear crystal 2, the o-polarized idler light can be correspondingly obtained. The wavelengths of the pump light 3 and the second signal light 5 are degenerate or nearly degenerate, that is to say, the wavelength of the second signal light 5 is twice or nearly twice that of the pump light 3. At this time, regardless of the e-polarized component or the o-polarized component of the second signal light 5, the phase mismatch accumulated in the nonlinear crystal 2 is less than π, i.e. |Δk·L|<π, wherein |Δk·L| represents the accumulated phase mismatch, and π represents Pi.

In the radially polarized optical parametric amplifier insensitive to polarization according to embodiment 1 of the present invention, the pump light and the signal light with an arbitrary polarization state (such as radially polarized light) generated by the laser module enter the nonlinear crystal satisfying the type-II phase matching or the type-II quasi-phase matching condition, and optical parametric amplification of the signal light is performed by using the pump light, thereby obtaining high-peak-power ultrashort pulsed laser with the initialized polarization state. The radially polarized optical parametric amplifier insensitive to polarization according to the present invention is insensitive to the polarization of signal light, that is, no matter what kind of the polarization state of signal light is, the power of signal light obtained after being amplified by pump light is only related to the power of seeding signal light and has nothing to do with its polarization state. The optical parametric amplifier can be used for parametric amplification of vector beams such as the radially polarized light to obtain the high-peak-power radially polarized ultrashort pulsed laser.

### Embodiment 2

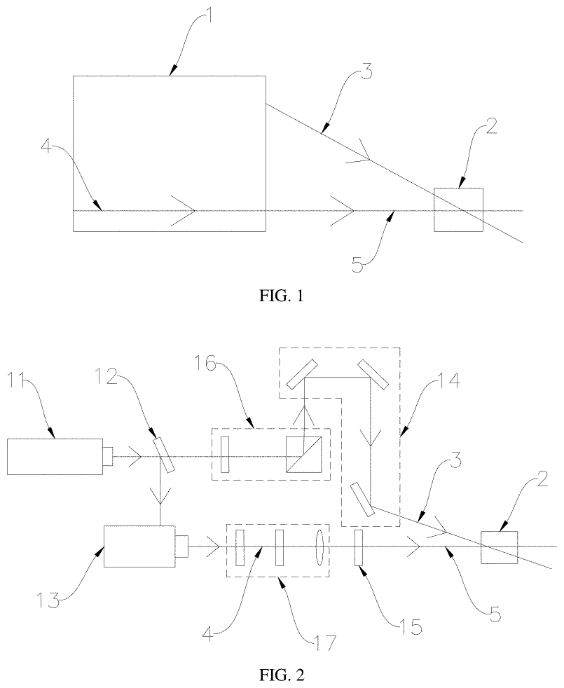

Refer to FIG. 2, which is a schematic diagram of a radially polarized optical parametric amplifier insensitive to polarization according to embodiment 2 of the present invention.

Compared with the radially polarized optical parametric amplifier insensitive to polarization according to embodiment 1 of the present invention, embodiment 2 of the present invention gives the specific configuration of the laser module 1.

As shown in FIG. 2, the laser module 1 comprises a third laser 11, a beam splitter 12, a frequency converter 13, a delay optical path 14 and a laser mode converter 15, wherein the beam splitter 12 is provided at the output end of the third laser 11 at intervals to divide the laser emitted from the third laser 11 into two laser beams, namely a first laser beam and a second laser beam. The first laser beam is pump light 3, and the frequency converter 13 is provided in the beamline of the second laser beam, so as to perform frequency conversion on the second laser beam to obtain the first signal light 4. The laser mode converter 15 is provided in the beamline of the first signal light 4 to perform mode conversion on the first signal light 4 to obtain the second signal light 5. The delay optical path 14 is located next to the beam splitter 12 away from the third laser 11 and is provided in the beamline of the pump light 3 to control the time synchronization between the pump light 3 and the second signal light 5.

Specifically, the laser module 1 further comprises a control unit 16, which is located between the beam splitter 12 and the delay optical path 14 and is provided in the beamline of the pump light 3 to control the pulse energy of the pump light 3 entering the nonlinear crystal 2.

Specifically, the laser module 1 further comprises an adjusting unit 17, which is located between the frequency converter 13 and the laser mode converter 15 and is provided in the beamline of the first signal light 4 to adjust the pulse duration of the first signal light 4, the pulse energy of the second signal light 5 converted from the first signal light 4 entering the nonlinear crystal 2, and the spot size of the second signal light 5 converted from the first signal light 4 in the nonlinear crystal 2.

Optionally, in other embodiments, the delay optical path 14 is provided in the beamline of the first signal light 4.

For example, in the actual working process, the laser emitted from the third laser 11 is divided into a first laser beam and a second laser beam by the beam splitter 12. After being frequency-converted by the frequency converter 13, as the first signal light 4, the second laser beam is converted into a second signal light 5 by the adjusting unit 17 and the laser mode converter 15 in sequence, and then enters the nonlinear crystal 2. At the same time, as the pump light 3, the first laser beam enters the nonlinear crystal 2 in a non-collinear manner with the second signal light 5 after passing through the control unit 16 and the delay optical path 14 in sequence, so as to fulfill the optical parametric amplification of the second signal light 5 by using the pump light 3.

Optionally, in other embodiments, as the pump light 3, the first laser beam enters the nonlinear crystal 2 in a collinear manner with the second signal light 5 after passing through the control unit 16 and the delay optical path 14 in sequence to obtain the amplified second signal light 5. At this time, in order to separate the amplified second signal light 5 from the attenuated pump light 3 and the idler light, it is necessary to provide a beam splitter in the emergent beamline of the nonlinear crystal 2. The beam splitter is a dichroic mirror highly transparent to the amplified second signal light 5 and highly reflective to the attenuated pump light 3 and the idler light, or a dichroic mirror highly transparent to the attenuated pump light 3 and the idler light and highly reflective to the amplified second signal light 5.

### Embodiment 3

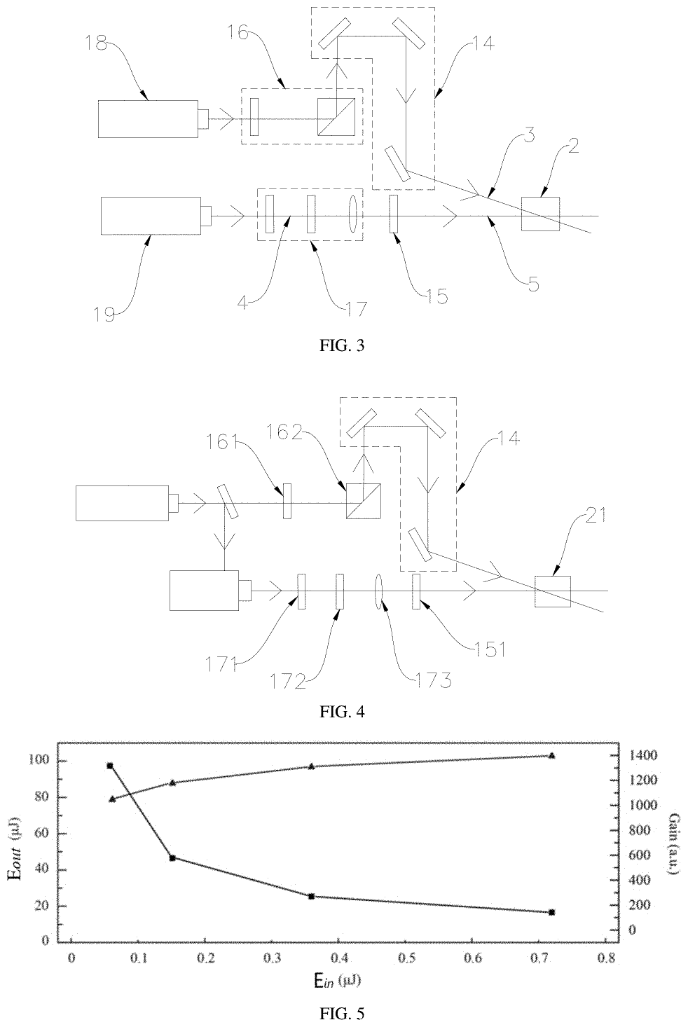

Refer to FIG. 3, which is a schematic diagram of a radially polarized optical parametric amplifier insensitive to polarization according to embodiment 3 of the present invention.

Compared with the radially polarized optical parametric amplifier insensitive to polarization provided in embodiment 2 of the present invention, in embodiment 3 of the present invention, the laser module 1 has another configuration.

As shown in FIG. 3, the laser module 1 comprises a first laser 18, a second laser 19, a delay optical path 14 and a laser mode converter 15, wherein the first laser 18 and the second laser 19 are provided at intervals, the first laser 18 is configured to generate the pump light 3, and the second laser 19 is configured to generate the first signal light 4. The laser mode converter 15 is provided in the beamline of the first signal light 4 to perform mode conversion on the first signal light 4 to obtain the second signal light 5, and the delay optical path 14 is provided in the beamline of the pump light 3 to control the time synchronization between the pump light 3 and the second signal light 5.

Specifically, the laser module 1 further comprises a control unit 16, which is located between the first laser 18 and the delay optical path 14 and is provided in the beamline of the pump light 3 to control the pulse energy of the pump light 3 entering the nonlinear crystal 2.

Specifically, the laser module 1 further comprises an adjusting unit 17, which is located between the second laser 19 and the laser mode converter 15 and is provided in the beamline of the first signal light 4 to adjust the pulse duration of the first signal light 4, the pulse energy of the second signal light 5 converted from the first signal light 4 entering the nonlinear crystal 2, and the spot size of the second signal light 5 converted from the first signal light 4 in the nonlinear crystal 2.

For example, in the actual working process, the first signal light 4 emitted from the second laser 19 enters the nonlinear crystal 2 after being converted into the second signal light 5 by passing through the adjusting unit 17 and the laser mode converter 15 in sequence. Meanwhile, the pump light 3 emitted from the first laser 18 passes through the control unit 16 and the delay optical path 14 in sequence, and enters the nonlinear crystal 2 in a non-collinear manner with the second signal light 5, so as to fulfill the optical parametric amplification of the second signal light 5 by using the pump light 3.

### Embodiment 4

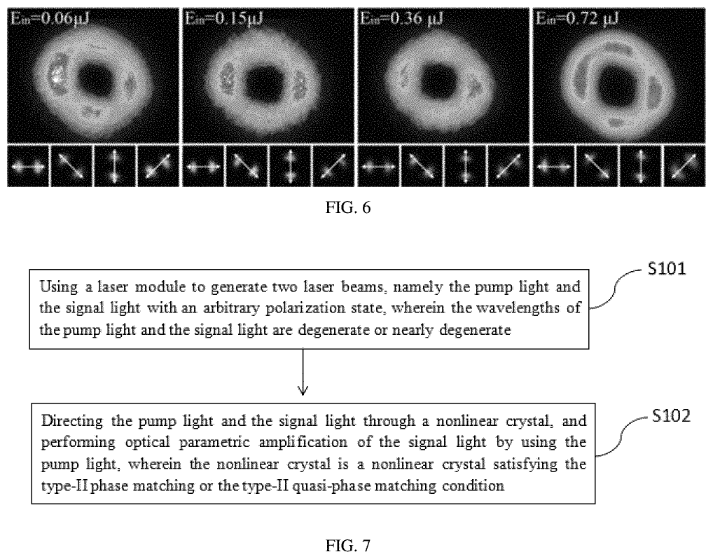

Refer to FIG. 4, FIG. 5 and FIG. 6. FIG. 4 is a schematic diagram of the radially polarized optical parametric amplifier insensitive to polarization according to embodiment 4 of the present invention; FIG. 5 is a curve showing the evolution of the average pulse energy and gain of the radially polarized light after being amplified versus the average pulse energy of the seeding radially polarized light according to embodiment 4 of the present invention; FIG. 6 is a CCD camera image of the spot of the amplified radially polarized light after appropriately attenuating the pulse energy of the amplified radially polarized light according to embodiment 4 of the present invention.

Compared with the radially polarized optical parametric amplifiers insensitive to polarization according to embodiment 2 and 3 of the present invention, in embodiment 4 of the present invention, the specific configuration of the adjusting unit 17, the control unit 16 and the laser mode converter 15 is provided, and the nonlinear crystal 2 is selected.

As shown in FIG. 4, the adjusting unit 17 comprises a variable attenuation filter 172, a lens 173 and a narrow-band filter 171. The narrow-band filter 171, the variable attenuation filter 172 and the lens 173 are sequentially provided in the beamline of the first signal light 4 along the direction from the frequency converter 13 to the laser mode converter 15 or the direction from the second laser 19 to the laser mode converter 15.

In particular, the center wavelength of the narrow-band filter 171 is the same as the wavelength of the first signal light 4, and the narrow-band filter 171 can adjust the pulse duration of the first signal light 4, thereby matching the pulse durations of the pump light 3 and the first signal light 4, and reducing the influence of pulse slipping on the gain. The variable attenuation filter 172 can adjust the pulse energy of the second signal light 5 converted from the first signal light 4 entering the nonlinear crystal 2. The lens 173 can adjust the spot size of the second signal light 5 converted from the first signal light 4 in the nonlinear crystal 2, thus avoiding the problem that the spot of the amplified second signal light 5 is distorted because the spot of the second signal light 5 in the nonlinear crystal 2 is smaller than the spot of the pump light 3 in the nonlinear crystal 2, that is, the spot of the amplified second signal light 5 is distorted due to non-uniform optical parametric amplification.

As shown in FIG. 4, the control unit 16 comprises a half-wave plate 161 and a Glan polarizer 162, wherein the half-wave plate 161 and the Glan polarizer 162 are located between the beam splitter 12 and the delay optical path 14 or between the first laser 18 and the delay optical path 14 and are provided in the beamline of the pump light 3.

As shown in FIG. 4, the laser mode converter 15 comprises a vortex retarder 151, which is configured to convert the first signal light 4 into the radially polarized signal light 5.

In particular, the vortex retarder 151 is a vortex retarder with a topological charge of 1.

In addition, in this embodiment, the nonlinear crystal 2 is a BBO crystal 21 with a preset cutting angle and length.

It should be noted that the BBO crystal 21 also performs as a wave plate, and in order to maintain the original polarization state for the amplified second signal light 5, it is necessary to design the crystal length of the BBO crystal 21 reasonably, or fine-tune the crystal angle of the BBO crystal 21 in practical operation, so that the BBO crystal 21 is an ideal full-wave plate for the second signal light 5.

In order to clearly understand the radially polarized optical parametric amplifier insensitive to polarization according to embodiment 4 of the present invention, the optical parametric amplification process of the radially polarized optical parametric amplifier insensitive to polarization according to embodiment 4 of the present invention will be illustrated with reference to embodiment 2 of the present invention.

A third laser 11 is a Ti:sapphire femtosecond laser, which emits femtosecond pulsed laser with a wavelength of 800 nm, a single pulse energy of 7 mJ and a repetition frequency of 1 kHz.

After passing through the beam splitter 12, the femtosecond pulsed laser with a wavelength of 800 nm is divided into two beams of pulsed laser, namely the first femtosecond pulsed laser at 800 nm with single pulse energy of 4 mJ and the second femtosecond pulsed laser at 800 nm with single pulse energy of 3 mJ.

The first femtosecond pulsed laser at 800 nm with single pulse energy of 4 mJ enters the optical parametric generator as the frequency converter 13 to obtain femtosecond pulsed laser at 1610 nm as the first signal light 4, and the second femtosecond pulsed laser at 800 nm with single pulse energy of 3 mJ is used as the pump light 3.

The first signal light 4 passes through the narrow-band filter 171 with a center wavelength of 1610 nm and a bandwidth of 12 nm, so that the pulse duration of the first signal light 4 becomes about 400 fs. After that, the first signal light 4 passes through the variable attenuation filter 172 and the lens 173 in sequence, and then after being converted into the radially polarized second signal light 5 by the vortex retarder 151 with a topological charge of 1, the first signal light 4 enters the BBO crystal 21 with a length of 1 mm and a cutting angle of 0=28.8°, which meets the type-II phase matching condition. It is worth noting that the BBO crystal 21 plays a role similar to a full-wave plate for the second signal light 5.

The pump light 3 passes through the half-wave plate 161, the Glan polarizer 162 and the delay optical path 14 in sequence, and then enters the BBO crystal 21 in a non-collinear manner with the radially polarized second signal light 5 (the non-collinear angle between the pump light 3 and the radially polarized signal light 5 is about 1.4°). In this process, the pump light 3 is temporally stretched to about 280 fs by controlling the initial chirp of the pump light 3.

Due to the self-focusing effect, the spot diameter (Full Width At Half Maximum FWHM) of pump light 3 in the BBO crystal 21 is about 1.5 mm after long-distance transmission. In order to make the spot of the radially polarized second signal light 5 in the BBO crystal 21 smaller than that of the pump light 3 in the BBO crystal 21, a plano-convex lens with focal length of 1000 mm is selected as the lens 173 to weakly focus the first signal light 4, so that the spot diameter (Full Width At Half Maximum FWHM) of the second signal light 5 in the BBO crystal 21 is about 0.5 mm.

Finally, taking BBO crystal 21 as a nonlinear crystal, the optical parametric amplification of radially polarized second signal light 5 is fulfilled by using the pump light 3, then the amplified second signal light 5 and the residual pump light 3 are obtained, and the idler light is generated at the same time. Due to the non-collinear transmission among the pump light 3, the amplified second signal light 5 and the idler light, the amplified second signal light 5 can be spatially separated from the residual pump light 3 and the idler light.

In this embodiment, the single pulse energy of the pump light 3 is about 2.9 mJ. Furthermore, the measurement of the pulse energy, energy distribution and polarization distribution of the amplified second signal light 5 is performed at the position of about 40 cm behind the BBO crystal 21, and the measurement results are shown in FIGS. 5 and 6.

It can be seen from FIG. 5 that when the pulse energy of the seeding radially polarized second signal light 5 is 60 nJ, the radially polarized optical parametric amplifier insensitive to polarization according to this embodiment can obtain the largest amplification of 1300. It can be seen from FIG. 6 that a clear annular spot can always be obtained with different seeding pulse energies of the second signal light 5. In order to confirm the polarization characteristics of the amplified second signal light 5, a conventional measuring mean is used to transmit the amplified second signal light 5 through the linear polarizer and record the profiles at different polarization angles. Corresponding to each annular spot in FIG. 6, we can obtain a “double-lobe” profile which is parallel to the polarization direction of the linear polarizer and rotates with the change of this polarization direction, which is the typical feature of radially polarized light.

### Embodiment 5

Refer to FIG. 7, which is a schematic flow chart of the optical parametric amplification method insensitive to polarization according to embodiment 5 of the present invention.

As shown in FIG. 7, the realization of the optical parametric amplification method insensitive to polarization according to embodiment 5 of the present invention is based on the radially polarized optical parametric amplifier insensitive to polarization according to any one of embodiments 1 to 4 of the present invention, and the amplification method comprises:

S101, using a laser module to generate two laser beams, namely the pump light and the signal light with an arbitrary polarization state, wherein the wavelengths of the pump light and the signal light are degenerate or nearly degenerate;

S102, directing the pump light and the signal light through a nonlinear crystal, and performing optical parametric amplification of the signal light by using the pump light, wherein the nonlinear crystal is a nonlinear crystal satisfying the type-II phase matching or the type-II quasi-phase matching condition.

Specifically, for the specific configuration of the laser module and the amplification method based on the specific configuration of the laser module, refer to the radially polarized optical parametric amplifier insensitive to polarization according to any one of embodiments 2 to 4 of the present invention, which will not be described in detail here.

In order to clearly understand the radially polarized optical parametric amplifier insensitive to polarization and amplification method according to the above embodiments of the present invention, the principle of the radially polarized optical parametric amplifier insensitive to polarization according to the above embodiments of the present invention will be explained hereinafter.

In order to realize the optical parametric amplification of radially polarized light, an optical parametric amplifier which is insensitive to polarization is essentially required. The optical parametric amplifier needs to meet two basic requirements. First, the gain has nothing to do with the polarization state of the signal light to be amplified (equivalent to the second signal light in the above embodiment of the present invention, hereinafter referred to as signal light), but is only related to the energy of the seeding signal light; second, the polarization state or polarization distribution of the amplified signal light will not be changed due to optical parametric amplification.

Theoretically, a signal light with an arbitrary polarization state can be divided into the o-polarized component and the e-polarized component which are orthogonal to each other. As long as the gain of these two orthogonal polarization components are consistent, the original polarization state can be retained for the amplified signal light; otherwise, the polarization state of the amplified signal light will be changed.

In order to realize optical parametric amplification insensitive to polarization, degenerate or near-degenerate type-II optical parametric amplifiers can be used to perform synchronous optical parametric amplification on both of the o-polarized component and the e-polarized component of the signal light. Taking the type-II optical parametric amplifiers pumped by Ti:sapphire laser at 800 nm as an example, the pump light of 800 nm is e-polarized, and the o-polarized component and the e-polarized component of the 1600 nm signal light can be regarded as two independent signal lights. Accordingly, in such a optical parametric amplification process, o-polarized signal light can correspondingly generate e-polarized idler light, while e-polarized signal light can correspondingly generate o-polarized idler light. As the optical parametric amplifier used is a type-II degenerate optical parametric amplifiers, the above two optical parametric amplification processes can both satisfy the phase matching condition (Δkₒ=Δkₑ=0, where Δkₒ represents the phase mismatch of o-polarized signal light, and Δkₑ represents the phase mismatch of e-polarized signal light). Therefore, both of the o-polarized light and the e-polarized signal light can obtain energy from the same pump light at 800 nm and can be synchronously amplified.

If the wavelength of the signal light is slightly detuned, for example, to 1610 nm, it will become a type-II near-degenerate optical parametric amplification. Then, the optical parametric amplification of signal light at 1610 nm can be decomposed into the optical parametric amplification of o-polarized light at 1610 nm by the e-polarized light at 800 nm to generate the e-polarized light at 1590 nm; and the optical parametric amplification of e-polarized light at 1610 nm by the e-polarized light at 800 nm to generate the o-polarized light at 1590 nm. Theoretically, although it is impossible to make such two synchronous optical parametric amplification processes can both satisfy the perfect phase matching condition by adjusting the angle of the nonlinear crystal, the values of phase mismatch can be made to be equal (i.e. |Δkₒ|≈|Δkₑ|≠0). As long as the gain of the o-polarized component and the e-polarized component of the signal light can be consistent, optical parametric amplification insensitive to polarization can still be realized. Compared with the type-II degenerate optical parametric amplification, the maximum acceptable wavelength offset of the type-II near-degenerate optical parametric amplification is determined by the values of Δkₒ and Δkₑ and the crystal length L of the nonlinear crystal. Generally, it is required that the accumulated phase mismatch in the nonlinear crystal should be less than π, that is, |Δkₒ·L|<π and |Δkₑ·L|<π, regardless of the o-polarized component or the e-polarized component of the signal light.

Restricted by the limited bandwidth and damage threshold, it is generally impossible to directly generate few-cycle radially polarized pulsed laser by the diffractive optical devices with polarization selectivity. Theoretically, based on the optical parametric amplifier insensitive to polarization, few-cycle radially polarized pulsed laser can be indirectly generated in that case of few-cycle linearly polarized ultrashort pulsed laser is employed as the pump light. In order to further improve the peak power of vector beams such as the radially polarized light, it can even be extended to an optical parametric chirped pulse amplifier insensitive to polarization based on optical parametric amplifier insensitive to polarization, which is expected to boosting the peak power of radially polarized light to several TW and even 100 TW.

It should be noted that each embodiment in the context of the present invention is described in a progressive manner, each embodiment focuses on the differences from other embodiments, and the same and similar parts among the embodiments can be referred to each other. As for the method embodiment, because it is similar to the product embodiment, the description is relatively simple, and relevant points can be found in the partial description of the product embodiment.

It should also be noted that in the context of the present invention, relational terms such as first and second are only used to distinguish one entity or operation from another entity or operation, and do not necessarily require or imply any such actual relationship or order between these entities or operations. Furthermore, the terms “including”, “comprising” or any other variation thereof are intended to cover non-exclusive inclusion, so that a process, method, article or device including a series of elements comprises not only those elements, but also other elements not explicitly listed, or elements inherent to such process, method, article or device. Without further limitation, the element defined by the sentence “including a . . . ” does not exclude that there are other identical elements in the process, method, article or device including the element.

The above description of the disclosed embodiments enables those skilled in the art to implement or use the context of the present invention. Many modifications to these embodiments will be obvious to those skilled in the art, and the general principles defined in the context of the present invention can be implemented in other embodiments without departing from the spirit or scope of the context of the present invention. Therefore, the context of the present invention will not be limited to the embodiments shown in the context of the present invention, but will conform to the widest scope consistent with the principles and novel features disclosed in the context of the present invention.

What is claimed is:

1. A radially polarized optical parametric amplifier insensitive to polarization comprising a laser module and a nonlinear crystal satisfying a type-II phase matching or a type-II quasi-phase matching condition, wherein the laser module is configured to generate two laser beams, and the two laser beams are pump light and signal light, the signal light is of arbitrary polarization, wavelengths of the pump light and the signal light are degenerate or nearly degenerate, and the nonlinear crystal is provided in an emergent beamline of the laser module to perform optical parametric amplification of the signal light by using the pump light.

2. The radially polarized optical parametric amplifier of claim 1, wherein different nonlinear crystals are used corresponding to the signal light with different wavelengths, so that gain of an o-polarized component and an e-polarized component of the signal light are equivalent and the signal light passing through the nonlinear crystal is capable of maintaining the original polarization state.

3. The radially polarized optical parametric amplifier of claim 1, wherein the laser module comprises a first laser and a second laser, the first laser emits the pump light and the second laser emits the signal light;
optionally, the laser module comprises a third laser, a beam splitter and a frequency converter, the laser emitted by the third laser passes through the beam splitter and two laser beams are obtained, one of which is the pump light and the other passes through the frequency converter and generates the signal light.

4. The radially polarized optical parametric amplifier of claim 3, wherein the third laser is a Ti:sapphire femtosecond laser, which emits femtosecond pulsed laser, and the femtosecond pulsed laser passes through the beam splitter and two laser beams are obtained, one of which is the pump light and the other passes through the frequency converter and generates the signal light.

5. The radially polarized optical parametric amplifier of claim 3, wherein the laser module further comprises a laser mode converter provided in the beamline of the signal light for changing the polarization state of the signal light.

6. The radially polarized optical parametric amplifier of claim 5, wherein the laser mode converter is a vortex retarder for converting the linearly polarized signal light into the radially polarized signal light.

7. The radially polarized optical parametric amplifier of claim 3, wherein the laser module further comprises a lens and a delay optical path, wherein the delay optical path is provided in the beamline of the signal light or the pump light, so that the signal light and the pump light are synchronized in time, the lens is provided in the beamline of the signal light or the pump light in such a way that the spot of the signal light is smaller than or equal to the spot of the pump light.

8. The radially polarized optical parametric amplifier of claim 1, wherein when the nonlinear crystal performs optical parametric amplification of the signal light by using the pump light, another laser beam will be generated, which is idler light, in the nonlinear crystal, a non-collinear phase matching method is used, wherein the transmission directions of the signal light and the pump light are non-collinear, so as to separate the signal light passing through the nonlinear crystal from the pump light and the idler light;
optionally, in the nonlinear crystal, a collinear phase matching method is used, wherein the transmission directions of the signal light and the pump light are collinear, and the optical parametric amplifier further comprises a beam splitter which is provided in the emergent beamline of the nonlinear crystal to separate the signal light passing through the nonlinear crystal from the pump light and the idler light.

9. The radially polarized optical parametric amplifier of claim 8, wherein the beam splitter is a dichroic mirror which is highly transparent to the signal light and highly reflective to the pump light and the idler light;
optionally, the beam splitter is a dichroic mirror which is highly transparent to the pump light and the idler light and highly reflective to the signal light.

10. An optical parametric amplification method insensitive to polarization, wherein the method is applied to the radially polarized optical parametric amplifier of claim 1, the method comprises:
using the laser module to generate two laser beams, wherein the two laser beams are pump light and signal light, wherein the signal light is of arbitrary polarization, and wavelengths of the pump light and the signal light are degenerate or nearly degenerate;
directing the pump light and the signal light through a nonlinear crystal, and performing optical parametric amplification of the signal light by using the pump light, wherein the nonlinear crystal is a nonlinear crystal satisfying the type-II phase matching or the type-II quasi-phase matching condition.
